(19) United States
(12) Patent Application Publication
(10) Pub. No.: US 2026/0253890 A1
(43) Pub. Date: Aug. 27, 2026

(54) METAL COMPLEX HYDROXIDE, METHOD FOR PRODUCING THE SAME, AND CATHODE ACTIVE MATERIAL OF NONAQUEOUS ELECTROLYTE SECONDARY BATTERY

(71) Applicant: TANAKA CHEMICAL CORPORATION, Fukui (JP)

(72) Inventor: Naoya HANAMURA, Fukui (JP)

(73) Assignee: TANAKA CHEMICAL CORPORATION, Fukui (JP)

(21) Appl. No.: 19/549,687

(22) Filed: Feb. 25, 2026

(30) Foreign Application Priority Data
Feb. 26, 2025 (JP) 2025-029071

(51) Int. Cl. H01M 4/525; C01G 53/42; C01G 53/84

(52) U.S. Cl. CPC H01M 4/525; C01G 53/42; C01G 53/84; C01P 2002/50; C01P 2006/12; C01P 2006/40

(57) ABSTRACT

Provided is a metal complex hydroxide that includes nickel and cobalt, which is a precursor of a cathode active material of a nonaqueous electrolyte secondary battery, wherein a drying rate DTG₂ at 40° C. obtained when a water content of the metal complex hydroxide is 2 mass % is 70.0% or less of a drying rate DTG₁₅ at 40° C. obtained when a water content of the metal complex hydroxide is 15 mass %.

### CROSS REFERENCE TO RELATED APPLICATIONS

The present application claims the benefit of foreign priority to Japanese Patent Application No. 2025-029071, filed on Feb. 26, 2025, which is incorporated herein by reference in its entirety.

### BACKGROUND

### Technical Field

The present disclosure relates to a metal complex hydroxide, a method for producing the same, and a cathode active material of a nonaqueous electrolyte secondary battery.

### Description of the Related Art

In recent years, from the viewpoint of reducing environmental load, secondary batteries have been used in a wide range of fields, including portable devices such as mobile phones and portable personal computers, as well as vehicles that use or combine electricity as power sources. Examples of the secondary batteries include, for example, nonaqueous electrolyte secondary batteries such as lithium-ion secondary batteries. These nonaqueous electrolyte secondary batteries are suitable for miniaturization and weight reduction, and exhibit various excellent battery characteristics.

Nickel and cobalt are known to be included in a cathode active material of a nonaqueous electrolyte secondary battery. For example, Japanese Translation of PCT International Application Publication No. 2020-537298 discloses a cathode active material for a secondary battery that is a lithium complex transition metal oxide, which includes nickel and cobalt and includes one or more selected from the group consisting of manganese and aluminum, wherein a content of nickel is 60 mol % or more in the entire transition metal, the lithium complex transition metal oxide is doped with one or more doping elements, and a weight decrease rate at 600° C. is 1.0% or less and a weight decrease rate at 900° C. is 2.0% or less in thermogravimetry (TGA).

### SUMMARY

A precursor of a cathode active material of a nonaqueous electrolyte secondary battery may be stored over a certain period of time before mixing with a lithium compound to be fired. During storage, the amount of moisture contained in the precursor may change, and a variation in the amount of moisture in the precursor leads to deterioration of a yield. In addition, the quality of the obtained cathode active material may be affected. The present disclosure is related to providing a precursor of a cathode active material of a nonaqueous electrolyte secondary battery having an improved variation of an amount of moisture due to storage and a cathode active material using the same.

The present disclosure relates to, for example, a metal complex hydroxide that includes nickel and cobalt, which is a precursor of a cathode active material of a nonaqueous electrolyte secondary battery, wherein a drying rate DTG₂ at 40° C. obtained when a water content of the metal complex hydroxide is 2 mass % is 70.0% or less of a drying rate DTG₁₅ at 40° C. obtained when a water content of the metal complex hydroxide is 15 mass %.

In addition, the present disclosure relates to a method for producing a metal complex hydroxide that includes nickel and cobalt, which is a precursor of a cathode active material of a nonaqueous electrolyte secondary battery, the method including: a reaction step of supplying a metal-containing aqueous solution that contains nickel and cobalt, a complexing agent that is an ammonium ion donor, and an alkaline aqueous solution to a reaction vessel and subjecting them to crystallization reaction, to obtain a hydroxide, wherein, in the reaction step, a value obtained by dividing a cobalt concentration (g/L) in the metal-containing aqueous solution to be supplied to the reaction vessel by an ammonium ion concentration (g/L) in the reaction vessel is 0.01 or more and 5.0 or less.

According to an embodiment of the present disclosure, it is possible to provide a precursor of a cathode active material of a nonaqueous electrolyte secondary battery having an improved variation of an amount of moisture due to storage and a cathode active material using the same.

### DETAILED DESCRIPTION

The following lists exemplary aspects of the present disclosure.
[1] A metal complex hydroxide that includes nickel and cobalt, which is a precursor of a cathode active material of a nonaqueous electrolyte secondary battery, wherein a drying rate DTG₂ at 40° C. obtained when a water content of the metal complex hydroxide is 2 mass % is 70.0% or less of a drying rate DTG₁₅ at 40° C. obtained when a water content of the metal complex hydroxide is 15 mass %.
[2] The metal complex hydroxide according to [1], wherein a drying rate DTG₄ at 40° C. obtained when a water content of the metal complex hydroxide is 4 mass % is 96.3% or less of the drying rate DTG₁₅ at 40° C. obtained when the water content of the metal complex hydroxide is 15 mass %.
[3] The metal complex hydroxide according to [1] or [2], wherein a drying rate DTG₆ at 40° C. obtained when a water content of the metal complex hydroxide is 6 mass % is 98.0% or less of the drying rate DTG₁₅ at 40° C. obtained when the water content of the metal complex hydroxide is 15 mass %.
[4] The metal complex hydroxide according to any one of [1] to [3], wherein a BET specific surface area is 5 m²/g or more and 55 m²/g or less.
[5] The metal complex hydroxide according to any one of [1] to [4], wherein the metal complex hydroxide contains 60 mol % or more of a nickel atom relative to a total amount of contained metal atoms.
[6] The metal complex hydroxide according to any one of [1] to [5], wherein the metal complex hydroxide includes nickel (Ni) and cobalt (Co), and optionally one or more additional elements (M) selected from the group consisting of Mn, Al, Fe, Ti, Mg, Ca, Sr, Ba, V, Nb, Cr, Mo, W, Ru, Cu, Zn, B, Ga, Si, Sn, P, Bi, and Zr, wherein a molar ratio of Ni:Co:M is 1-x-y:x:y (0<x≤0.2, 0≤y≤0.2).
[7] A cathode active material of a nonaqueous electrolyte secondary battery, which is a fired product of the metal complex hydroxide according to any one of [1] to [6] and a lithium compound.
[8] A method for producing a metal complex hydroxide that includes nickel and cobalt, which is a precursor of a cathode active material of a nonaqueous electrolyte secondary battery, the method including: a reaction step of supplying a metal-containing aqueous solution that contains nickel and cobalt, a complexing agent that is an ammonium ion donor, and an alkaline aqueous solution to a reaction vessel and subjecting them to crystallization reaction, to obtain a hydroxide, wherein, in the reaction step, a value obtained by dividing a cobalt concentration (g/L) in the metal-containing aqueous solution to be supplied to the reaction vessel by an ammonium ion concentration (g/L) in the reaction vessel is 0.01 or more and 5.0 or less.
[9] The method according to [8], wherein a drying rate DTG₂ at 40° C. obtained when a water content of the metal complex hydroxide is 2 mass % is 70.0% or less of a drying rate DTG₁₅ at 40° C. obtained when a water content of the metal complex hydroxide is 15 mass %.

### Metal Complex Hydroxide

Hereinafter, a metal complex hydroxide, which is a precursor of a cathode active material of a nonaqueous electrolyte secondary battery, will be described in detail. A metal complex hydroxide of the present disclosure includes nickel and cobalt, and a drying rate DTG₂ at 40° C. obtained when a water content of the metal complex hydroxide is 2 mass % is 70.0% or less of a drying rate DTG₁₅ at 40° C. obtained when a water content of the metal complex hydroxide is 15 mass %.

In the metal complex hydroxide of the present disclosure, the drying rate DTG₂ at 40° C. obtained when the water content is 2 mass % (hereinafter, may be referred to as “DTG₂”) is preferably 60% or less, more preferably 50% or less, still more preferably 40% or less, and particularly preferably 30% or less of the drying rate DTG₁₅ at 40° C. obtained when the water content is 15 mass % (hereinafter, may be referred to as “DTG₁₅”). As DTG₂ is smaller relative to DTG_{15,} adsorption of moisture in an atmosphere during storage of the metal complex hydroxide is easily suppressed. The lower limit value of DTG₂ is not particularly limited, and, for example, may be 1% or more, may be 5% or more, or may be 10% or more of DTG_{15.}

In the metal complex hydroxide of the present disclosure, the drying rate DTG₄ at 40° C. obtained when the water content is 4 mass % (hereinafter, may be referred to as “DTG₄”) is preferably 90% or less, more preferably 80% or less, still more preferably 70% or less, and particularly preferably 60% or less of DTG₁₅. As DTG₄ is smaller relative to DTG₁₅, adsorption of moisture in an atmosphere during storage of the metal complex hydroxide is easily suppressed for a longer period of time. The lower limit value of DTG₄ is not particularly limited, and, for example, may be 10% or more, may be 20% or more, or may be 30% or more of DTG₁₅.

In the metal complex hydroxide of the present disclosure, the drying rate DTG₆ at 40° C. obtained when the water content is 6 mass % (hereinafter, may be referred to as “DTG₆”) is preferably 95% or less, more preferably 85% or less, still more preferably 80% or less, and particularly preferably 75% or less of DTG_{15.} As DTG₆ is smaller relative to DTG₁₅, adsorption of moisture in an atmosphere during storage of the metal complex hydroxide is easily suppressed for a longer period of time. The lower limit value of DTG₆ is not particularly limited, and, for example, may be 10% or more, may be 20% or more, or may be 30% or more of DTG₁₅.

In one preferable embodiment, in the metal complex hydroxide, DTG₂ is 60% or less of DTG₁₅, DTG₄ is 90% or less of DTG₁₅, and DTG₆ is 95% or less of DTG₁₅. In one more preferable embodiment, in the metal complex hydroxide, DTG₂ is 50% or less of DTG₁₅, DTG₄ is 80% or less of DTG₁₅, and DTG₆ is 85% or less of DTG₁₅. In one still more preferable embodiment, in the metal complex hydroxide, DTG₂ is 40% or less of DTG₁₅, DTG₄ is 70% or less of DTG₁₅, and DTG₆ is 80% or less of DTG₁₅. In one particularly preferable embodiment, in the metal complex hydroxide, DTG₂ is 30% or less of DTG₁₅, DTG₄ is 60% or less of DTG₁₅, and DTG₆ is 75% or less of DTG₁₅.

In the present disclosure, the water content, DTG₂, DTG₄, DTG₆, and DTG₁₅ are measured by the following methods.

### Measurement Methods of Water Content and Drying Rates

As an apparatus, a simultaneous thermogravimetry-differential thermal analysis apparatus (TG-DTA apparatus) is used. A gas flow rate (dry air) is set to 200 mL/min. A sample obtained by adding 10 mg of distilled water to 10 mg of the metal complex hydroxide, which is dried at 100° C. for an hour in a tray-type drier in advance, is placed in a measurement pan. A setting temperature of the apparatus of 30° C. is set to a starting temperature, and a temperature is programed to be increased to 40° C. at a rate of temperature increase of 15° C./min from the starting temperature, to perform drying for 40 minutes from the start of temperature increase (period 1). In the period 1, the weight TG (ug) of the sample is measured, which is differentiated by time, to obtain DTG (ug/min). After the end of the period 1, a temperature is increased to 110° C. at a rate of temperature increase of 10° C./min, to perform additional drying for 40 minutes from the start of temperature increase (period 2). The sample at end of the period 2 is defined as an absolute dry condition (water content 0%). The water content at each point of time is calculated by {1−(sample weight in absolute dry condition/sample weight at each time during period 1)}×100. From DTG at a point of time when the water content is 2 mass %, 4 mass %, 6 mass %, and 15 mass %, DTG_{2,} DTG_{4,} DTG_{6,} and DTG₁₅ are calculated.

The metal complex hydroxide of the present disclosure preferably includes 60 mol % or more of nickel atoms, more preferably includes 70 mol % or more of nickel atoms, still more preferably includes 75 mol % or more of nickel atoms, and particularly preferably includes 80 mol % or more of nickel atoms, relative to the total amount of contained metal atoms. As the content of nickel atoms in the metal complex hydroxide is larger, initial charge and discharge efficiency, cycle characteristics, and the like are more advantageous, and cost of raw materials is easily saved. Moreover, the content of nickel atoms in the metal complex hydroxide of the present disclosure is, for example, preferably less than 100 mol %, more preferably 98 mol % or less, still more preferably 97 mol % or less, and particularly preferably 96 mol % or less, relative to the total amount of contained metal atoms. The lower limit value and the upper limit value of the content of nickel atoms in the metal complex hydroxide of the present disclosure can be optionally combined within the disclosed range. For example, the content of nickel atoms in the metal complex hydroxide of the present disclosure is preferably 60 mol % or more and less than 100 mol %, more preferably 70 mol % or more and 98 mol % or less, still more preferably 75 mol % or more and 97 mol % or less, and particularly preferably 80 mol % or more and 96 mol % or less, relative to the total amount of the contained metal atoms.

Preferably, the metal complex hydroxide of the present disclosure includes nickel (Ni) and cobalt (Co), and optionally one or more additional elements (M) selected from the group consisting of Mn, Al, Fe, Ti, Mg, Ca, Sr, Ba, V, Nb, Cr, Mo, W, Ru, Cu, Zn, B, Ga, Si, Sn, P, Bi, and Zr, wherein a molar ratio of Ni:Co:M is 1-x-y:x:y (0<x≤0.2, 0≤y≤0.2). Particularly, the metal complex hydroxide of the present disclosure preferably includes one or more selected from the group consisting of Mn, Al, and Mg, and more preferably includes one or more selected from the group consisting of Mn and Al, as the additional elements (M).

x is preferably 0.01≤x≤0.15, more preferably 0.015≤x≤0.1, still more preferably 0.02≤x≤0.08, and particularly preferably 0.03≤x≤0.06. y is preferably 0≤y≤0.15, more preferably 0≤y≤0.1, still more preferably 0≤y≤0.08, and particularly preferably 0≤y≤0.06.

The metal complex hydroxide of the present disclosure may include secondary particles formed by aggregating a plurality of primary particles. The particle shape of the metal complex hydroxide of the present disclosure is not particularly limited, and may have a wide variety of shapes. Examples of the shape of the primary particle can include, for example, a needle shape, a plate shape, and a columnar shape. Examples of the shape of the secondary particles can include, for example, a substantially spherical shape and a substantially oval shape.

In the metal complex hydroxide of the present disclosure, a particle diameter of secondary particles at 50 vol % of a cumulative volume percentage (D50) (hereinafter, may be simply referred to as “D50”) is not particularly limited. In the metal complex hydroxide of the present disclosure, D50 of secondary particles is preferably 3.0 μm or more, more preferably 6.0 μm or more, and still more preferably 10.0 μm or more, from the viewpoint of improving the packing density of the cathode active material into a cathode. In the metal complex hydroxide of the present disclosure, D50 of secondary particles is preferably 20.0 μm or less, more preferably 18.0 μm or less, and still more preferably 15.0 μm or less, from the viewpoint of improving the contactability with an electrolyte. The upper limit value and the lower limit value of D50 of secondary particles in the metal complex hydroxide of the present disclosure can be optionally combined within the disclosed range. For example, D50 of secondary particles in the metal complex hydroxide of the present disclosure is preferably 3.0 μm or more and 20.0 μm or less, more preferably 6.0 um or more and 18.0 μm or less, and still more preferably 10.0 μm or more and 15.0 μm or less. Note that, D50 is measured with a particle size distribution measurement apparatus using a laser diffraction· scattering method.

In the metal complex hydroxide of the present disclosure, regarding D50 of secondary particles, a particle diameter of secondary particles at 10 vol % of the cumulative volume percentage (D10), and a particle diameter of the secondary particles at 90 vol % of the cumulative volume percentage (D90), (D90-D10)/D50 is preferably 1.2 or less, more preferably 0.9 or less, and still more preferably 0.5 or less. Moreover, (D90-D10)/D50 is, for example, preferably 0.2 or more, more preferably 0.3 or more, and still more preferably 0.4 or more. The upper limit value and the lower limit value of (D90-D10)/D50 can be optionally combined within the disclosed range. For example, (D90-D10)/D50 is preferably 0.2 or more and 1.2 or less, more preferably 0.3 or more and 0.9 or less, and still more preferably 0.4 or more and 0.5 or less. D10 and D90 are measured with a particle size distribution measurement apparatus using a laser diffraction·scattering method, in the similar manner as in D50.

The BET specific surface area of the metal complex hydroxide of the present disclosure is not particularly limited. For example, the BET specific surface area of the metal complex hydroxide of the present disclosure is preferably 5 m²/g or more, more preferably 10 m²/g or more, and still more preferably 15 m²/g or more, from the viewpoint of improving the packing density of the cathode active material into a cathode and the contactability with a nonaqueous electrolyte. Moreover, the BET specific surface area of the metal complex hydroxide of the present disclosure is preferably 55 m²/g or less, more preferably 50 m²/g or less, and still more preferably 45 m²/g or less, from the viewpoint of improving crush strength of the cathode active material. The lower limit value and the upper limit value of the BET specific surface area can be optionally combined within the disclosed range. For example, the BET specific surface area of the metal complex hydroxide of the present disclosure is preferably 5 m²/g or more and 55 m²/g or less, more preferably 10 m²/g or more and 50 m²/g or less, and still more preferably 15 m²/g or more and 45 m²/g or less.

The tap density of the metal complex hydroxide of the present disclosure is not particularly limited. For example, the tap density of the metal complex hydroxide of the present disclosure is preferably 1.3 g/mL or more, and more preferably 1.5 g/mL or more, from the viewpoint of improving the packing density of the cathode active material into a cathode. Moreover, for example, the tap density of the metal complex hydroxide of the present disclosure may be 2.3 g/mL or less, or may be 2.2 g/mL or less, from the viewpoint of improving the contactability between a cathode active material and a non-aqueous electrolyte. The lower limit value and the upper limit value of the tap density can be optionally combined within the disclosed range. For example, the tap density of the metal complex hydroxide of the present disclosure is preferably 1.3 g/mL or more and 2.3 g/mL or less, and more preferably 1.5 g/mL or more and 2.2 g/mL or less.

The reason why a precursor of a cathode active material of a nonaqueous electrolyte secondary battery having an improved variation of an amount of moisture due to storage is obtained from the present disclosure is not necessarily clear, but there is a possibility that a metal complex hydroxide having sufficiently small DTG₂ relative to DTG₁₅ has a structure (pore size, volume, or the like) in which adsorption/desorption rates of moisture are extremely small in a region where the water content is small by multiple phenomena due to movement of water to the particle surface by capillary force, descent of the evaporated surface inside of the particle, and diffusion or evaporation of water in pore space. Therefore, it is believed that variation of the amount of moisture due to storage is not simply affected by only the size of the BET specific surface area, but is also affected by the balance between various parameters such as a pore size and pore patterns.

### Method for Producing Metal Complex Hydroxide

Next, a method for producing the metal complex hydroxide of the present disclosure will be described. The metal complex hydroxide of the present disclosure can be produced by a method including a reaction step of supplying a metal-containing aqueous solution that contains nickel and cobalt, a complexing agent that is an ammonium ion donor, and an alkaline aqueous solution to a reaction vessel and subjecting them to crystallization reaction, to obtain a hydroxide.

In the reaction step, a metal-containing aqueous solution that contains nickel and cobalt, a complexing agent, and an alkaline aqueous solution are added into a reaction vessel to be mixed, and undergo coprecipitation reaction in a reaction solution, to obtain a hydroxide.

Specifically, by a co-precipitation method, a metal salt solution that contains a nickel salt (for example, a sulphate), a cobalt salt (for example, a sulphate), and a salt of an optional additional element (M) (for example, a sulphate) (hereinafter, may be simply referred to as “metal-containing aqueous solution”), an alkaline aqueous solution, and a complexing agent are appropriately added to a reaction vessel, and are crystallized through neutralization reaction in the reaction vessel, to obtain a slurry suspension that contains a hydroxide. As a solvent of the suspension, for example, water is used.

The complexing agent can form a complex with nickel, cobalt, and an additional element (M) in an aqueous solution. In the present disclosure, an ammonium ion donor is used as the complexing agent. Examples of the ammonium ion donor include ammonium sulfate, ammonium chloride, ammonium carbonate, and ammonium fluoride.

The alkaline aqueous solution is not particularly limited as long as the pH value of the aqueous solution is adjusted in co-precipitation. Examples of the alkaline aqueous solution include aqueous solutions of alkali metal hydroxides (for example, sodium hydroxide and potassium hydroxide).

When the metal-containing aqueous solution, the alkaline aqueous solution, and the complexing agent described above are supplied to a reaction vessel, nickel, cobalt, and an additional element (M) undergo crystallization reaction, to produce a metal complex hydroxide. In the crystallization reaction, while the temperature in the reaction vessel is controlled to, for example, 45° C. or more and 75° C. or less, and preferably 60° C. or more and 70° C. or less, the pH value in the reaction vessel is controlled to, for example, pH 10.0 or more and pH 13.0 or less, and preferably pH 10.3 or more and pH 12.0 or less based on the solution temperature of 40° C., and the substances in the reaction vessel are appropriately stirred.

While a value obtained by dividing a concentration of cobalt (g/L) in the metal-containing aqueous solution to be supplied to a reaction vessel by a concentration of ammonium ions (NH₄⁺) (g/L) in the reaction vessel is maintained to 0.01 or more and 5.0 or less, preferably 0.02 or more and 4.0 or less, more preferably 0.03 or more and 3.5 or less, still more preferably 0.04 or more and 3.0 or less, and particularly preferably 0.05 or more and 2.0 or less, the reaction step can be performed to produce the metal complex hydroxide of the present disclosure.

When the reaction step is a continuous type, the prepared hydroxide is allowed to continuously overflow from an overflow pipe of a reaction vessel to discharge the hydroxide to the outside of the reaction vessel. In the case of a batch type, after reaction for a predetermined period of time, the reaction is stopped, and the total amount of the metal complex compound in the reaction vessel is discharged to the outside of the system using a pump or the like.

In the reaction step, in the case of a continuous type, a part of a slurry containing the obtained hydroxide is allowed to overflow from a reaction vessel to be discharged to the outside of the reaction vessel. Moreover, in the case of a batch type, a part of a slurry containing the obtained hydroxide can be allowed to overflow from the reaction vessel to be extracted (slurry extracting step). The extracted slurry is concentrated in the concentration vessel (concentration step). The concentration step is a step of increasing the concentration of the metal complex hydroxide in the slurry. The concentration step may be performed by an optional solid liquid separation method (for example, filtration, precipitation, extraction, and the like). The slurry concentrated by the concentration step is returned to the reaction vessel (return step). Therefore, in the reaction vessel, while an unreacted metal-containing aqueous solution and the slurry returned by the return step are supplied together, the reaction step is performed. The slurry concentration (the concentration of the metal complex hydroxide) in the reaction vessel increases over time as the reaction proceeds. The reaction may be stopped after predetermined amounts of the metal-containing aqueous solution, the alkaline aqueous solution, and the complexing agent are charged and then a predetermined time passes. After the stop of the reaction, the hydroxide can be extracted from the reaction vessel using a pump or the like, to extract the total amount.

After the slurry containing the hydroxide obtained as described above is filtrated, the hydroxide is washed with an alkaline aqueous solution, it is separated into the solid phase and the liquid phase by the solid liquid separation, and the solid phase that contains the hydroxide can be obtained. If necessary, the solid phase that contains the hydroxide may be dried to obtain a hydroxide powder. If necessary, before the solid phase is dried, the solid phase may be washed with water or the like. If necessary, the hydroxide powder obtained by drying the solid phase is charged into the reaction vessel again, and may be used as seed crystal particles for performing batch reaction. The hydroxide obtained in the above manner may be an oxide by further oxidizing the hydroxide. Examples of the method for obtaining the oxide from the hydroxide can include, for example, performing an oxidization treatment with firing under an atmosphere in which oxygen gas exists at a temperature of 300° C. or more and 800° C. or less for 1 hour or more and 10 hours or less.

### Cathode Active Material

Next, a cathode active material for a nonaqueous electrolyte secondary battery (hereinafter, may be simply referred to as “the cathode active material of the present disclosure”), which is a fired product of the metal complex hydroxide of the present disclosure and a lithium compound, will be described. The cathode active material of the present disclosure is an aspect in which the metal complex hydroxide of the present disclosure is fired with the lithium compound. The metal complex hydroxide of the present disclosure can be fired with the lithium compound to obtain a cathode active material having stable quality.

The crystalline structure of the cathode active material of the present disclosure is a layered structure, and is preferably a trigonal crystalline structure, a hexagonal crystalline structure, or a monoclinic crystalline structure from the viewpoint of obtaining a secondary battery having a high discharge capacity. The cathode active material of the present disclosure can be used, for example, as a cathode active material of a nonaqueous electrolyte secondary battery such as a lithium-ion secondary battery.

Next, a method for producing the cathode active material of the present disclosure will be described. For example, in the method for producing the cathode active material of the present disclosure, first, a lithium compound is added to the metal complex hydroxide of the present disclosure or an oxide obtained by oxidizing the metal complex hydroxide of the present disclosure to prepare a mixture. The lithium compound is not particularly limited as long as it is a compound including lithium, and examples of the lithium compound can include, for example, lithium carbonate and lithium hydroxide.

When the mixture is prepared, the lithium compound and the precursor of the present disclosure may be mixed so that, for example, a molar ratio of lithium of the lithium compound to the total amount of the contained metal atoms (the total amount of nickel, cobalt, and the additional element) of the metal complex hydroxide of the present disclosure falls within a range of 1.00 or more and 1.10 or less.

Next, the above-described mixture can be fired to produce a cathode active material. Examples of the firing condition include, for example, a firing temperature of 600° C. or more and 1000° C. or less, a rate of temperature increase of 50° C./h or more and 300° C./h or less, and a firing time of 5 hours or more and 20 hours or less. The firing may be performed, for example, under an air atmosphere or under an oxygen atmosphere. In addition, a firing furnace used for firing is not particularly limited, and examples of the firing furnace include a static box furnace and a continuous furnace of roller hearth type.

### Nonaqueous Electrolyte Secondary Battery

A cathode using the cathode active material of the present disclosure, an anode, an electrolytic solution containing a predetermined electrolyte, and a separator can be prepared by a known method to assemble a nonaqueous electrolyte secondary battery.

The cathode includes a cathode current collector, and a cathode active material layer using the cathode active material of the present disclosure formed on a surface of the cathode current collector. The cathode active material layer has the cathode active material of the present disclosure, a binding agent (binder), and, if necessary, a conductive additive. The conductive additive is not particularly limited as long as it can be used for the nonaqueous electrolyte secondary battery, and, for example, carbon-based materials can be used. Examples of the carbon-based materials can include graphite powder, carbon black (for example, acetylene black), and fibrous carbon materials. The binding agent is not particularly limited, and, for example, thermoplastic resins can be used. Examples of the thermoplastic resin can include polyvinylidene fluoride (PVdF), butadiene rubber (BR), polyvinyl alcohol (PVA), carboxymethyl cellulose (CMC), polytetrafluoroethylene (PTFE), and combinations thereof. The cathode current collector is not particularly limited, but examples of the cathode current collector can include, for example, electrically conductive metal materials such as aluminum foil, nickel foil, and stainless steel.

The cathode is obtained by mixing, for example, a cathode active material, a conductive additive, and a binding agent to prepare a cathode active material slurry, filling a cathode current collector with the cathode active material slurry by a known filling method, and drying the slurry, followed by rolling and fixing with a press or the like.

Examples of the anode can include an electrode in which an anode active material layer including an anode active material is supported on an anode current collector, and an electrode consisting of an anode active material alone. The anode active material is not particularly limited as long as it is usually used, and, for example, graphite such as natural graphite and artificial graphite, cokes, carbon black, pyrolytic carbons, carbon fibers, and fired bodies of organic polymer compounds can be used. The anode current collector is not particularly limited, and examples of the anode current collector can include, for example, metal materials such as copper foil, nickel foil, and stainless steel. The anode may be metal lithium.

To the anode active material layer, a conductive additive, a binder, and the like may be further added if necessary. Examples of the conductive additive and the binder include the same as those used in the above-described cathode active material layer.

The anode is obtained by mixing, for example, an anode active material, and if necessary, a conductive additive, a binding agent, and water to prepare an anode active material slurry, filling an anode current collector with the anode active material slurry by a known filling method, and drying the slurry, followed by rolling and fixing with a press or the like.

Examples of the electrolyte contained in the nonaqueous electrolyte include LiCIO₄, LiPF₆, LiASF₆, LiSbF₆, LIBF₄, LiCF₃SO₃, LIN(SO₂CF₃)₂, LIN(SO₂C₂F₅)₂, LIN(SO₂CF₃) (COCF₃), Li(C₄F₉SO₃), LiC(SO₂CF₃)₃, Li₂B₁₀Ch₁₀, LiBOB (where, BOB is bis (oxalato) borate), LiFSI (where, FSI is bis (fluorosulfonyl) imide), lithium salts of lower aliphatic carboxylic acid, lithium salts of LiAlCl₄ and the like. These may be used alone or may be used in combination of two or more kinds.

As a dispersion medium of the electrolyte, for example, carbonates such as propylene carbonate, ethylene carbonate, dimethyl carbonate, diethyl carbonate, ethyl methyl carbonate, 4-trifluoromethyl-1,3-dioxolan-2-one, and 1,2-di(methoxycarbonyloxy)ethane; ethers such as 1,2-dimethoxyethane, 1,3-dimethoxypropane, pentafluoropropyl methyl ether, 2,2,3,3-tetrafluoropropyl difluoromethyl ether, tetrahydrofuran, and 2-methyltetrahydrofuran; esters such as methyl formate, methyl acetate, and y-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, 1,3-propanesultone, or those obtained by further introducing fluoro groups into these organic solvents (those in which one or more hydrogen atoms included in the organic solvents are substituted with fluorine atoms) can be used. These may be used alone or may be used in combination of two or more kinds.

In addition, in place of the electrolyte-containing electrolytic solution, a solid electrolyte may be used. As the solid electrolyte, for example, organic polymer electrolytes such as polyethylene oxide-based polymer compounds, or polymer compounds containing at least one or more kinds of polyorganosiloxane chains or polyoxyalkylene chains may be used. A so-called gel-type electrolyte, in which a nonaqueous electrolytic solution is held in a polymer compound, may also be used. Moreover, examples of the solid electrolyte include inorganic solid electrolytes containing sulfides such as Li₂S—SiS₂, Li₂S—GeS₂, Li₂S—P₂S₅, Li₂S—B₂S₃, Li₂S—SiS₂—Li₃PO₄, Li₂S—SiS₂—Li₂SO₄, and Li₂S—GeS₂—P₂S₅. These may be used alone or may be used in combination of two or more kinds.

The separator is not particularly limited, but for example, materials in the forms of porous membranes, nonwoven fabrics, woven fabrics, and the like, which are formed of polyolefin resins such as polyethylene and polypropylene, fluororesin, nitrogen-containing aromatic polymers can be used. These may be used alone or may be used in combination of two or more kinds.

### EXAMPLES

Next, the present disclosure will be described in more detail by way of Examples and the like, but the present disclosure is not limited to these Examples and the like.

### Production of Precursor (Metal Complex Hydroxide)

### Example 1

A metal-containing aqueous solution obtained by dissolving nickel sulfate, cobalt sulfate, and manganese sulfate so that a molar ratio of nickel:cobalt:manganese was 92:3:5, an ammonium sulfate aqueous solution (complexing agent), and a sodium hydroxide aqueous solution were added dropwise to a reaction vessel having a predetermined volume, and were continuously stirred with a stirring machine while the temperature in the reaction vessel was maintained at 70° C. and the pH in the reaction vessel was maintained at 11.8 based on the solution temperature of 40° C. During reaction, the cobalt concentration in the metal-containing aqueous solution to be added dropwise to the reaction vessel was controlled to 3.0 g/L, and the ammonium ion concentration in the reaction vessel was controlled to 1.0 g/L. The generated hydroxide was allowed to overflow from an overflow pipe of the reaction vessel and was introduced into a concentration vessel. In the concentration vessel, the generated hydroxide was subjected to solid liquid separation, a supernatant was discharged to thereby concentrate the hydroxide, and the concentrated hydroxide was returned into the reaction vessel. Charging of each solution was stopped 50 hours after the start of the reaction, to stop the reaction. At that time, the particle diameter (particle diameter at 50 vol % of cumulative volume percentage (D50)) was 4 μm. After the stop of the reaction, the hydroxide was extracted from the reaction vessel using a pump or the like, and the total amount of the hydroxide extracted was subjected to treatments of washing with water, dehydration, and drying, to obtain a metal complex hydroxide of Example 1.

### Example 2

A metal-containing aqueous solution obtained by dissolving nickel sulfate, cobalt sulfate, and manganese sulfate so that a molar ratio of nickel:cobalt:manganese was 90:5:5, an ammonium sulfate aqueous solution (complexing agent), and a sodium hydroxide aqueous solution were added dropwise to a reaction vessel having a predetermined volume, and were continuously stirred with a stirring machine while the temperature in the reaction vessel was maintained at 70° C. and the pH in the reaction vessel was maintained at 11.5 based on the solution temperature of 40° C. 0.5 hours after the start of reaction, the pH in the reaction vessel was changed to 10.5 based on the solution temperature of 40° C., and was maintained until the reaction stopped. During reaction, the cobalt concentration in the metal-containing aqueous solution to be added dropwise to the reaction vessel was controlled to 5.0 g/L, and the ammonium ion concentration in the reaction vessel was controlled to 2.0 g/L. The generated hydroxide was allowed to overflow from an overflow pipe of the reaction vessel and was introduced into a concentration vessel. In the concentration vessel, the generated hydroxide was subjected to solid liquid separation, a supernatant was discharged to thereby concentrate the hydroxide, and the concentrated hydroxide was returned into the reaction vessel. Charging of each solution was stopped 50 hours after the start of the reaction, to stop the reaction. The subsequent steps were performed in the similar manner as in Example 1 to obtain a metal complex hydroxide (batch 1). A part of the obtained metal complex hydroxide was returned to the reaction vessel together with hot water. Then, a metal-containing aqueous solution obtained by dissolving nickel sulfate, cobalt sulfate, and manganese sulfate so that a molar ratio of nickel:cobalt:manganese was 90:5:5, an ammonium sulfate aqueous solution (complexing agent), and a sodium hydroxide aqueous solution were added dropwise to a reaction vessel having a predetermined volume, and were continuously stirred with a stirring machine while the temperature in the reaction vessel was maintained at 70° C. and the pH in the reaction vessel was maintained at 10.5 based on the solution temperature of 40° C. The stirring power at that time was set to a value that was lower than the stirring power in the previously performed batch reaction. During reaction, the cobalt concentration in the metal-containing aqueous solution to be added dropwise to the reaction vessel was controlled to 5.0 g/L, and the ammonium ion concentration in the reaction vessel was controlled to 2.0 g/L. The generated hydroxide was allowed to overflow from an overflow pipe of the reaction vessel and was introduced into a concentration vessel. In the concentration vessel, the generated hydroxide was subjected to solid liquid separation, a supernatant was discharged to thereby concentrate the hydroxide, and the concentrated hydroxide was returned into the reaction vessel. Charging of each solution was stopped 30 hours after the start of the reaction, to stop the reaction. At that time, the particle diameter (particle diameter at 50 vol % of cumulative volume percentage (D50)) was 10 μm. The subsequent steps were performed in the similar manner as in Example 1 to obtain a metal complex hydroxide of Example 2 (batch 2).

### Example 3

A metal-containing aqueous solution obtained by dissolving nickel sulfate, cobalt sulfate, and manganese sulfate so that a molar ratio of nickel:cobalt:manganese was 90:5:5, an ammonium sulfate aqueous solution (complexing agent), and a sodium hydroxide aqueous solution were added dropwise to a reaction vessel having a predetermined volume, and were continuously stirred with a stirring machine while the temperature in the reaction vessel was maintained at 70° C. and the pH in the reaction vessel was maintained at 10.6 based on the solution temperature of 40° C. During reaction, the cobalt concentration in the metal-containing aqueous solution to be added dropwise to the reaction vessel was controlled to 5.0 g/L, and the ammonium ion concentration in the reaction vessel was controlled to 2.5 g/L. The generated hydroxide was allowed to overflow from an overflow pipe of the reaction vessel to be discharged to the outside of the reaction vessel. At that time, the particle diameter (particle diameter at 50 vol % of cumulative volume percentage (D50)) was 13 um. The subsequent steps were performed in the similar manner as in Example 1 to obtain a metal complex hydroxide of Example 3.

### Example 4

A metal-containing aqueous solution obtained by dissolving nickel sulfate, cobalt sulfate, and aluminum sulfate so that a molar ratio of nickel:cobalt:aluminum was 94:4:2, an ammonium sulfate aqueous solution (complexing agent), and a sodium hydroxide aqueous solution were added dropwise to a reaction vessel having a predetermined volume, and were continuously stirred with a stirring machine while the temperature in the reaction vessel was maintained at 50° C. and the pH in the reaction vessel was maintained at 11.4 based on the solution temperature of 40° C. During reaction, the cobalt concentration in the metal-containing aqueous solution to be added dropwise to the reaction vessel was controlled to 4.5 g/L, and the ammonium ion concentration in the reaction vessel was controlled to 9.5 g/L. The generated hydroxide was allowed to overflow from an overflow pipe of the reaction vessel to be discharged to the outside of the reaction vessel. At that time, the particle diameter (particle diameter at 50 vol % of cumulative volume percentage (D50)) was 11 um. The subsequent steps were performed in the similar manner as in Example 1 to obtain a metal complex hydroxide of Example 4.

### Example 5

A metal-containing aqueous solution obtained by dissolving nickel sulfate, cobalt sulfate, and magnesium sulfate so that a molar ratio of nickel:cobalt:magnesium was 95:2:3, an ammonium sulfate aqueous solution (complexing agent), and a sodium hydroxide aqueous solution were added dropwise to a reaction vessel having a predetermined volume, and were continuously stirred with a stirring machine while the temperature in the reaction vessel was maintained at 48° C. and the pH in the reaction vessel was maintained at 12.0 based on the solution temperature of 40° C. During reaction, the cobalt concentration in the metal-containing aqueous solution to be added dropwise to the reaction vessel was controlled to 1.9 g/L, and the ammonium ion concentration in the reaction vessel was controlled to 14.0 g/L. The generated hydroxide was allowed to overflow from an overflow pipe of the reaction vessel to be discharged to the outside of the reaction vessel. At that time, the particle diameter (particle diameter at 50 vol % of cumulative volume percentage (D50)) was 10 μm. The subsequent steps were performed in the similar manner as in Example 1 to obtain a metal complex hydroxide of Example 5.

### Comparative Example 1

A metal-containing aqueous solution obtained by dissolving nickel sulfate, cobalt sulfate, and manganese sulfate so that a molar ratio of nickel:cobalt:manganese was 83:12:5, an ammonium sulfate aqueous solution (complexing agent), and a sodium hydroxide aqueous solution were added dropwise to a reaction vessel having a predetermined volume, and were continuously stirred with a stirring machine while the temperature in the reaction vessel was maintained at 70° C. and the pH in the reaction vessel was maintained at 11.2 based on the solution temperature of 40° C. During reaction, the cobalt concentration in the metal-containing aqueous solution to be added dropwise to the reaction vessel was controlled to 10.8 g/L, and the ammonium ion concentration in the reaction vessel was controlled to 2.1 g/L. The generated hydroxide was allowed to overflow from an overflow pipe of the reaction vessel to be discharged to the outside of the reaction vessel. At that time, the particle diameter (particle diameter at 50 vol % of cumulative volume percentage (D50)) was 11 μm. The subsequent steps were performed in the similar manner as in Example 1 to obtain a metal complex hydroxide of Comparative Example 1.

The hydroxides of Examples and Comparative Example were evaluated in the following manner.

### (1) Compositional Analysis of Metal Complex Hydroxide

After the obtained metal complex hydroxide was dissolved in hydrochloric acid, the compositional analysis was performed using an inductively coupled plasma emission analysis device (Optima 8300 available from PerkinElmer Japan G.K.).

### (2) Water Content and Drying Rate

A simultaneous thermogravimetry-differential thermal analysis apparatus (TG-DTA8122) available from Rigaku Corporation was used to calculate drying rates DTG (DTG_{2,} DTG_{4,} DTG_{6,} and DTG₁₅) of the metal complex hydroxides obtained in Examples and Comparative Example at a point of time of each water content by the above-described methods in the present specification.

### (3) Storage Test

50 g of each of the metal complex hydroxides obtained in Examples and Comparative Example was added to a polypropylene pipe whose lid was open, and was placed in a thermo-humidistat oven (40° C., humidity 85%) to be stored for 20 hours. An infrared moisture analyzer (FD-660, available from Kett Electric Laboratory Co. Ltd.) was used to measure the amount of moisture before and after storage.

### (4) BET Specific Surface Area

1 g of each of the metal complex hydroxides obtained in Examples and Comparative Example was dried at 105° C. for 30 minutes in a nitrogen atmosphere, and was measured by one point method for BET method using a specific surface area measurement machine (Macsorb, available from Mountech Co., Ltd.).

The above evaluation results are shown in Table 1 and Table 2.

TABLE 1

| | | Dropped solution Co | | | |
|---|---|---|---|---|---|
| | Composition | concentration/ | DTG₂/ | DTG₄/ | DTG₆/ |
| | (molar ratio | reaction vessel NH₄⁺ | DTG₁₅ × | DTG₁₅ × | DTG₁₅ × |
| | Ni/Co/M) | concentration | 100(%) | 100(%) | 100(%) |
| Example 1 | 92/3/5 | 3.0 | 44.7 | 68.5 | 84.4 |
| Example 2 | 90/5/5 | 2.5 | 58.6 | 79.0 | 88.1 |
| Example 3 | 90/5/5 | 2.0 | 52.6 | 66.7 | 75.9 |
| Example 4 | 94/4/2 | 0.5 | 25.5 | 45.8 | 54.2 |
| Example 5 | 95/2/3 | 0.1 | 44.9 | 96.2 | 98.0 |
| Comparative | 83/12/5 | 5.1 | 71.8 | 96.5 | 98.6 |
| Example 1 | | | | | |

TABLE 2

| | Amount of | Amount of | | |
|---|---|---|---|---|
| | moisture | moisture | | |
| | before storage A | after storage B | | BET specific |
| | (mass %) | (mass %) | B/A | surface area |
| Example 1 | 0.61 | 2.13 | 3.49 | 19.4 |
| Example 2 | 0.70 | 1.90 | 2.71 | 7.6 |
| Example 3 | 0.55 | 2.11 | 3.84 | 21.9 |
| Example 4 | 1.86 | 4.22 | 2.27 | 44.8 |
| Example 5 | 0.79 | 2.30 | 2.91 | 15.5 |
| Comparative | 0.28 | 1.29 | 4.61 | 7.1 |
| Example 1 | | | | |

In Examples 1 to 5, the reaction step was performed so that a value obtained by dividing the cobalt concentration (g/L) in the metal-containing aqueous solution to be supplied to the reaction vessel by the ammonium ion concentration (g/L) in the reaction vessel was 0.01 or more and 5.0 or less. In Comparative Example 1, the reaction step was performed so that this value was 5.1. In the metal complex hydroxides obtained in Examples 1 to 5, DTG₂ was 70.0% or less of DTG_{15.} On the other hand, in the metal complex hydroxide obtained in Comparative Example 1, DTG₂ was more than 70.0% of DTG_{15.} It is believed that cobalt, which greatly changes the size of primary particles depending on the reaction conditions, was appropriately crystallized and stacked, and thus DTG₂ reached 70.0% or less of DTG₂ by adjusting the cobalt concentration in the metal-containing aqueous solution and the ammonium ion concentration in the reaction vessel. In the metal complex hydroxides obtained in Examples 1 to 5, a change in the amount of moisture before and after storage fell within an acceptable range in the storage test in a high-temperature and high-humidity environment. On the other hand, in the metal complex hydroxide obtained in Comparative Example 1, the amount of moisture greatly changed before and after storage in the storage test in a high-temperature and high-humidity environment.

The secondary battery that includes the metal complex hydroxide and the cathode active material of the present disclosure is suitably applicable in a wide range of fields, including portable devices and vehicles.

What is claimed is:

1. A metal complex hydroxide that comprises nickel and cobalt, which is a precursor of a cathode active material of a nonaqueous electrolyte secondary battery,
wherein a drying rate DTG₂ at 40° C. obtained when a water content of the metal complex hydroxide is 2 mass % is 70.0% or less of a drying rate DTG₁₅ at 40° C. obtained when a water content of the metal complex hydroxide is 15 mass %.

2. The metal complex hydroxide according to claim 1, wherein a drying rate DTG₄ at 40° C. obtained when a water content of the metal complex hydroxide is 4 mass % is 96.3% or less of the drying rate DTG₁₅ at 40° C. obtained when the water content of the metal complex hydroxide is 15 mass %.

3. The metal complex hydroxide according to claim 1, wherein a drying rate DTG₆ at 40° C. obtained when a water content of the metal complex hydroxide is 6 mass % is 98.0% or less of the drying rate DTG₁₅ at 40° C. obtained when the water content of the metal complex hydroxide is 15 mass %.

4. The metal complex hydroxide according to claim 1, wherein a BET specific surface area is 5 m²/g or more and 55 m²/g or less.

5. The metal complex hydroxide according to claim 1, wherein the metal complex hydroxide contains 60 mol % or more of a nickel atom relative to a total amount of contained metal atoms.

6. The metal complex hydroxide according to claim 1,
wherein the metal complex hydroxide includes:
nickel (Ni);
cobalt (Co); and
optionally one or more additional elements (M) selected from the group consisting of Mn, Al, Fe, Ti, Mg, Ca, Sr, Ba, V, Nb, Cr, Mo, W, Ru, Cu, Zn, B, Ga, Si, Sn, P, Bi, and Zr,
wherein a molar ratio of Ni:Co:M is 1-x-y:x:y (0<x≤0.2, 0≤y≤0.2).

7. A cathode active material of a nonaqueous electrolyte secondary battery, which is a fired product of the metal complex hydroxide according to claim 1 and a lithium compound.
